(19) United States
(12) Patent Application Publication
(10) Pub. No.: US 2016/0024781 A1
(43) Pub. Date: Jan. 28, 2016

(54) ROBOTICALLY CONTROLLED ARCHITECTURAL ELEMENTS

(71) Applicant: Andrew Flessas, Las Vegas, NV (US)

(72) Inventor: Andrew Flessas, Las Vegas, NV (US)

(21) Appl. No.: 14/811,358

(22) Filed: Jul. 28, 2015

Related U.S. Application Data
(63) Continuation-in-part of application No. 14/502,495, filed on Sep. 30, 2014.
Application No. 14/502,495 is a continuation-in-part of application No. 13/745,945, filed on Jan. 21, 2013, now Pat. No. 8,896,242.
Application No. 13/745,945 is a continuation-in-part of application No. 12/653,058, filed on Dec. 7, 2009, now Pat. No. 8,356,704.
Application No. 12/653,058 is a continuation-in-part of application No. 12/455,638, filed on Jun. 3, 2009, now abandoned.
Application No. 12/455,638 is a continuation of application No. 11/700,535, filed on Jan. 30, 2007, now Pat. No. 7,545,108.
(60) Provisional application No. 62/030,228, filed on Jul. 29, 2014.
(60) Provisional application No. 60/736,699, filed on Nov. 15, 2005.

(51) Int. Cl. E04B 1/343; B25J 13/00; B25J 9/16

(52) U.S. Cl. CPC E04B 1/34352; B25J 9/1679; B25J 13/006; Y10S 901/02

(57) ABSTRACT

A robotic mount is configured to move an architectural element such as a floor, ceiling, wall or portion thereof, such as a panel, or plumbing, HVAC, or electrical elements. The robotic mount is movable in six degrees of freedom, whereby the associated architectural element is moveable in a three-dimensional space. In this manner, a configuration of an architectural space and/or the systems thereof, may be altered in an automated fashion.

### RELATED APPLICATION DATA

This application claims priority to U.S. Provisional Application Ser. No. 62/030,228, filed on Jul. 29, 2014, and is a continuation-in-part of U.S. application Ser. No. 14/502,495, filed Sep. 30, 2014, which is a continuation-in-part of U.S. application Ser. No. 13/745,945, filed Jan. 21, 2013, now U.S. Pat. No. 8,896,242, issued Nov. 25, 2014, which is a continuation-in-part of U.S. application Ser. No. 12/653,058, filed Dec. 7, 2009, now U.S. Pat. No. 8,356,704, issued Jan. 22, 2013, which is a continuation-in-part of U.S. application Ser. No. 12/455,638, filed Jan. 3, 2009, now abandoned, which is a continuation of U.S. patent application Ser. No. 11/700,535, filed Jan. 30, 2007, now U.S. Pat. No. 7,545,108, issued Jun. 9, 2009, which claims priority to U.S. Provisional Application Ser. No. 60/736,699, filed Jan. 31, 2006.

### FIELD OF THE INVENTION

The present invention relates to the movement of architectural and building elements.

### BACKGROUND OF THE INVENTION

Home automation continues to become more prevalent. Further, as populations rise, and as more flexibility for residential, industrial, and commercial spaces is desired to more efficiently use such spaces, there is a need for efficient and robust modification of architectural spaces.

Modification of architectural or building spaces is often employed in other settings as well. For example, in a theatrical production, large props may be located on a stage. The props may be moved into various positions to create different scenes and various actions. The props are often moved manually, such as with ropes and pulleys, limiting the situations where they may be used or their effectiveness.

Other building spaces are designed to be multi-purpose, allowing them to be reconfigured depending upon the particular use. For example, hotels, convention centers, cruise ships, casinos and other locations may have one or more large rooms which can be sub-divided or reconfigured for various uses. For example, a single large convention space might be divided into two or more sub-spaces, such as to accommodate two events occurring at one time. Sports arenas may be reconfigured depending upon the particular event being held (such as converting the arena from a configuration which includes a first arrangement of seating and a basketball court to a second configuration which includes a second arrangement of seating and an ice hockey rink).

A disadvantage to these spaces is the time and energy required to manually reconfigure them. For example, in the case of a convention center space, workers may unstack, move and assemble divider panels in order to divide a space, only to be required to disassemble, move and re-stack or store the panels when it is desired to use the room or space in an undivided configuration.

Buildings or other structures may be modified for other purposes as well. For example, shutters or coverings may be applied to a building in order to protect it during a storm. This generally requires workers to manually mount panels over windows, doors or other portions of the building or other structure. Thus, the act of storm-proofing a building is generally very costly and time consuming.

Improved methods of modifying buildings and other structures are desired.

### SUMMARY OF THE INVENTION

The invention comprises moveable architectural elements and methods of moving one or more architectural elements.

One embodiment of the invention is a robotic mount. The robotic mount is configured to support one or more architectural elements and move the one or more architectural elements in at least three degrees of freedom, and preferably in six degrees of freedom. In one embodiment, the robotic mount comprises a base and a movable support. The base supports the movable support, such as by resting upon a support surface or by connection to a support, such as a wall or other element.

The moveable support is movable in at least three, and preferably six, degrees of freedom, or directions whereby one or more architectural elements connected thereto are so movable. In one embodiment, the moveable support comprises a plurality of members which are movably connected to one another in one more directions/dimensions. The moveable support may comprise, for example, a robotic arm having a base, a main support which is rotatable relative to the base, a lower arm which is rotatable relative to the main support, an upper arm which is rotatable relative to the lower arm, and a head to which the one or more architectural elements are connected, the head movable relative to the upper arm.

In one embodiment, means are provided for moving the moveable support. Preferably, the means permits the moveable mount to be “automated” in the sense that it can be moved without direct physical contact by a human therewith. This means may comprise one or more electric motors or the like. Preferably, the entire robotic mount is also movable, such as by drive means which allows the robotic mount to be driven or moved from one location to another.

In one aspect of the invention, the architectural element is a robotically controlled panel. The robotically controlled panel preferably comprises a robotic mount which supports and moves one or more panel elements, such as used to form a wall, floor, ceiling or other architectural element or portion thereof

In other embodiments, the architectural element may comprise a staircase, an electrical system element, a plumbing system element, an HVAC system element or the like. The robotic mount is preferably configured to move those element in three-dimensional space, such as to change the configuration of a building.

Where the architectural elements are configured to be moved by a robotic mount, the architectural elements may be permanently affixed to the mount, or are more preferably releasably connectable thereto, such as to a head or other mount of the robotic mount. In one embodiment, architectural elements are modular, such as being in “cartridge” format which: (1) facilitates attachment and detachment of the architectural element from the robotic mount and (2) facilitates the connection of the architectural element to a structure or other architectural elements.

One embodiment of the invention is a system including a robotic mount and a controller. The controller may be configured to accept input from a user and/or run control programs for generating instructions or output signals which may be used to control the robotic mount and its associated architectural element (such as associated video display(s), video projector(s), switches, etc.).

Further objects, features, and advantages of the present invention over the prior art will become apparent from the detailed description of the drawings which follows, when considered with the attached figures.

### BRIEF DESCRIPTION OF THE DRAWINGS

FIG. 1 is a side view of a robotically controlled architectural element in accordance with an embodiment of the invention;

FIG. 2 illustrates a robotically controlled unitary panel comprising a plurality of individual displays in accordance with another embodiment of the invention;

FIG. 3 illustrates the unitary panel of FIG. 2 with the individual panels moved into different positions;

FIGS. 4 and 5 illustrate a robotically controlled staircase in accordance with an embodiment of the invention;

FIG. 6 is a block diagram of a system in accordance with one embodiment of the invention;

FIG. 7 illustrates one embodiment of a connector for selectively connecting a robotic mount to an architectural element of the invention; and

FIG. 8 illustrates a modular architectural element in accordance with an embodiment of the invention.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises one or more robotically-controlled objects and objects which are moved by one or more robots, such as architectural elements. The architectural elements may comprise floors, ceilings, walls (interior or exterior), roofs, facades, staircases, doors, plumbing components or elements, heating/ventilation/cooling (“HVAC”) elements, electrical system components or elements, and/or other architectural or building elements, as well as methods of moving such elements.

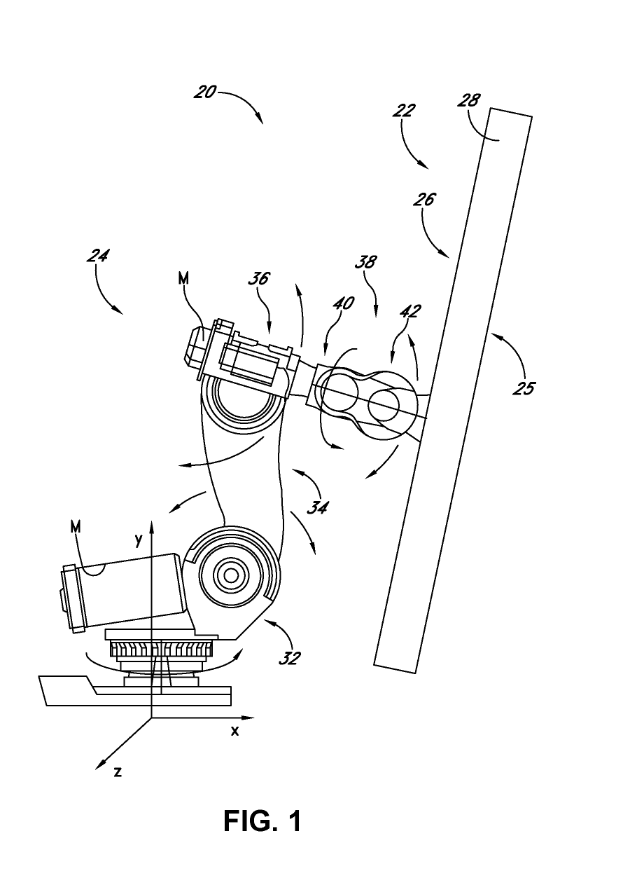

FIG. 1 illustrates a robotically controlled architectural element 20 in accordance with an embodiment of the invention. The architectural element may comprise or form a portion of a floor, ceiling, wall or other supporting or structural architectural element, such as for a residential, industrial, or commercial space/building. As illustrated, the robotically controlled architectural element 20 comprises at least one panel 22 which may comprise all or a portion of a ceiling, wall, or floor or other architectural element, and a robotic or moveable mount 24. In one embodiment, the panel 22 may be a floor or wall element, such as having supporting interior studs or other elements and a top or front side 25 and an opposing bottom or rear side 26. The panel 22 has a peripheral edge 28. In one embodiment, the panel 22 is generally rectangular in shape, but the panel 22 may have a variety of shapes. The panel 22 may be constructed from various materials, such as depending upon the application for the panel 22. When the panel 22 is used as a wall or portion of a wall, it may include wood or metal interior studs or supports and an exterior wood or drywall covering. When the panel 22 is used as a floor or portion of a floor, it may include wood or metal interior studs or supports and an exterior wood, stone or other covering, or it may comprise a solid material or the like. In other embodiments, the panel 22 may comprise glass, plastic or other material, or comprise or include other elements. For example, the panel 22 might include or comprise one or more video display devices, such as LED, LCD, CRT, OLED, DLP or other types of video displays which are capable of emitting light and/or displaying images (static and/or moving) and which may include touch or related features.

The panel 22 is supported by the robotic mount 24. In a preferred embodiment, the robotic mount 24 is moveable, thus permitting the position of the panel 22 to be changed. In a preferred embodiment, the robotic mount 24 is referred to as “robotic” because it is a device which can change positions without direct manual input. In particular, the robotic mount is preferably capable of multiple movements without manual intervention (i.e. move between various positions based upon a sequence of instructions without each movement being prompted by individual user input or without being pushed or moved by a user). Preferably, the robotic mount comprises a robot or robotic arm which can change the position of the panel 22 in at least three (3), and preferably six (6), degrees of freedom.

FIG. 1 illustrated one embodiment of a robotic mount 24. In one embodiment, the robotic mount 24 comprises a base and a support. The base is configured to connect or support the mount and associated panel to a support, and the support is preferably movable relative to the base, thus permitting an associated architectural element to be movable relative to the base and the associated support.

Referring to FIG. 1, the base 30 may have a variety of configurations, including various shapes and sizes. In one embodiment, the base 30 is configured to be mounted to (by connection or merely resting/setting upon) or supported by a support surface, such as a structural beam or other support, such as a portion of another object. In another embodiment, the base is configured to be moveable along a floor or track (for example, the robotic mount 24 might be mounted on rollers, wheels, tracks, feet or other devices/mechanisms which allow the robotic mount 24 to be moved, and/or include motors or other drive elements which allow the robotic mount 24 to drive, e.g. to allow the location of the robotic mount 24 to change; as one example, a robotic mount 24 might drive or move back and forth across a convention center floor from a location where panels are stored to a location where panels are to be assembled into a divider). The base 30 may have a generally planar bottom or lower surface for engaging a generally planar support surface, or may have other configurations for engaging support surfaces of other shapes. In one embodiment, the base 30 may include one or more apertures for accepting fasteners which are placed into engagement with the support surface, for securing the base 30 in a fixed position by temporarily or permanently connecting the base 30 to that surface.

In a preferred embodiment, a movable support is positioned between the base 30 and the panel 22. This support is preferably moveable in at least three (3), and more preferably six (6), degrees of freedom. By movement about degrees of freedom, it is preferably meant the support is movable in or about the “x,” “y,” and “z” axes in the standard Cartesian space.

As illustrated, in one embodiment, the robotic arm includes a main support 32. In one embodiment, the main support 32 is mounted for rotation relative to the base 30, i.e. about the “y” axis as illustrated in FIG. 1. The main support 32 may be mounted, for example, on a bearing supported shaft which is connected to the base 30, or by other means.

In one embodiment, a lower arm 34 is rotatably mounted to the main support 32. As illustrated, the main support 32 has a first portion mounted to the base 30 and a second portion to which the lower arm 34 is mounted. In a preferred embodiment, the lower arm 34 is rotatably mounted to the main support 32 about a shaft or other mount. In the configuration illustrated, the lower arm 34 is mounted for rotation about a “z” axis (i.e. an axis which is generally perpendicular to the axis about which the base 30 rotates).

As further illustrated, an upper arm 36 is rotatably mounted to the lower arm 34. In one embodiment, a first or distal portion of the lower arm 34 is mounted to the main support 32, and the upper arm 36 is mounted to a top or proximal portion of the lower arm 34. In one embodiment, as shown in FIG. 1, the upper arm 36 is also mounted for rotation about the “z” axis. That is, the upper arm 36 is mounted for rotation about an axis which is generally perpendicular to the axis about which the base 30 rotates.

In one embodiment, a head 38 is located at a distal portion of the upper arm 36. Preferably, the panel 22 is mounted to the mount 24 via the head 38. In one embodiment, the head 38 is mounted for rotation relative to the upper arm 36 (and thus the remainder of the mount 24). In one configuration, a first portion 40 of the head 38 is mounted for rotation about an “x” axis relative to the upper arm 36 (i.e., about an axis which is perpendicular to both the “y” and “z” axes, and thus about an axis which is generally perpendicular to the axis about which the main support 32 and upper and lower arms 36, 34 rotate).

Further, in the embodiment illustrated, a second portion 42 of the head 38 is mounted for rotation relative to the first portion 40 and the upper arm 36, about the “z” axis. As illustrated, the panel 22 is mounted to the second portion 42 of the head 38.

The various portions of the mount 24 may be connected to one another in a variety of fashions. For example, the various portions may be connected to one another via a shaft and bearing mount, where the shaft is connected to one component and engages one or more bearings supported by the other component, such that the shaft may move relative to the bearing(s), thus permitting the components to move relative to one another. The portions of the mount 24 might be mounted to one another in other fashions, however, such as by hinged mounting or the like.

Preferably, the mount 24 includes means for moving the one or more portions thereof, and thus the panel 22 connected thereto. As illustrated, the mount 24 may include one or more motors M for moving the components thereof. The motors M may be electrical motors. In other embodiments, hydraulics or other means may be utilized to move one or more of the components of the mount 24. For example, a hydraulic arm might be utilized to move the upper arm 36 relative to the lower arm 34 in an up and down direction.

In one embodiment, the panel 22 (or other architectural element) may be detachably connected to the mount 24, such as to permit the panel 22 to be changed or serviced. For example, the panel 22 that is detachable may be connected to the mount 24, moved to a desired location, secured in the desired location, and disconnected from the mount 24. In this manner, the robotic mount may be used to move a plurality of different panels 22. In another embodiment, the panel 22 may be permanently fixed to the mount 24. The panel 22 might be connected to a supporting frame, for example. That frame might then be detachably or permanently connected to the mount 24, such as by connecting the frame to the head 38 with one or more fasteners.

As indicated, in a preferred embodiment, the mount 24 is configured to move the panel 22 in six degrees of freedom or combinations thereof. The particular configuration of the mount 24 may vary for accomplishing this task. For example, while the mount 24 described above is “redundant” in its capacity to move in certain directions (i.e. the upper and lower arms 36, 34 are both configured to move about the “z” axis), the mount 24 could be configured in other fashions (such as by having only a single portion configured to move in each direction). It will also be appreciated that the number of members or elements which the mount comprises may vary. For example, the mount might comprise a base and a head which is mounted to the based, such as via a swivel, permitting the head to be moved in at least two dimensions. Various configurations of members may also be utilized to effect movement in various directions. For example, aside from swivels or the rotating connections of the mount illustrated in FIG. 1, members may be configured to telescope, slide or otherwise move linearly (i.e. move along an axis rather than about an axis), or be configured to move along paths other than curved paths. For example, the mount 24 may be configured to move about the “x” axis, such as to permit the panel to be tilted up and down, to move about the “y” axis, such as to permit the panel to be swiveled from side to side, and to simply move along the “z” axis, such as to permit the panel to be moved in and out (such as towards or away from a wall/viewer).

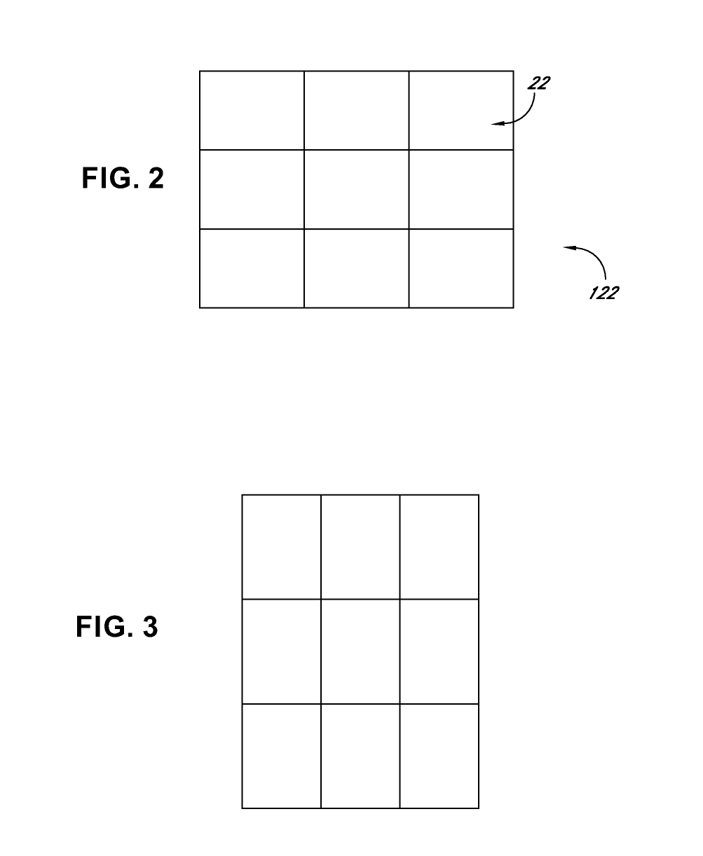

In the embodiment illustrated, a single panel 22 is connected to a single mount 24. In another embodiment of the invention, referring to FIG. 2, multiple panels may be placed within proximity to each other. Here, a unitary panel 122 may comprise a plurality of individual or independent panels 22 located in proximity to one another. In one embodiment, one or more of those individual panels may be mounted to a mount 24, and thus be configured for movement.

In operation, the robotically controlled architectural element 20 may move the panels 22 so as to reconfigure a residential, industrial, or commercial space. For example, the mount 24 may move one or more panels 22 to change the configuration of the ceiling, floor, or walls of a room. In this manner, the size and/or configuration of a room may be changed to efficiently and robustly utilize the same space in for different purposes.

It will be appreciated that a robotic mount might be configured to connect to connect to or more than one architectural element (such as via more than one head or mount than one mount or connection per head). Further, as indicated, the configuration of the robotic mount may vary, so long as the mount is capable of performing the functions herein.

FIG. 2 illustrates one embodiment of a unitary panel 122 comprising nine (9) panels 22. In one embodiment, all nine panels 22 are mounted to an associated mount (not shown). In this manner, each of the nine panels 22 may be moved by their associated mount. Alternatively, each panel may be moved separately by a single mount.

FIG. 2 illustrates the panels 22 in an orientation where they are located adjacent to one another in a matrix, and in a common plane. In the configuration illustrated, there is a central panel surrounded by top, bottom, side and corner panels.

The panels 22 may be moved, however, to other locations and thus other orientations or positions relative to one another. FIG. 3 illustrates the panels 22 again arranged in a matrix and in a single plane. However, in this configuration, the panels 22 have all been rotated 90 degrees, so that the unitary panel 122 is taller than wider.

In one embodiment, each panel 22 of the unitary panel 122 has an associated robotic mount. In this manner, each panel 22 may be moved independently of the other. In another embodiment, multiple panels may be coupled to or otherwise associated with a single mount (such that groups of panels are movable together). In yet another embodiment, one or more of the panels 22 may be fixed and others may be connected to a mount 24 for movement. In a further embodiment, each of the panels may be detachably connected to a single mount 24 and are moved separately into and out of position in the unitary panel 122.

In one embodiment, means may be provided for controlling a single mount (such as illustrated in FIG. 1) or one or more or all of a plurality of mounts (such as illustrated in FIG. 2). In one embodiment, one or more mounts may be controlled by a controller. The controller might comprise, for example, an electronically or mechanically operated controller.

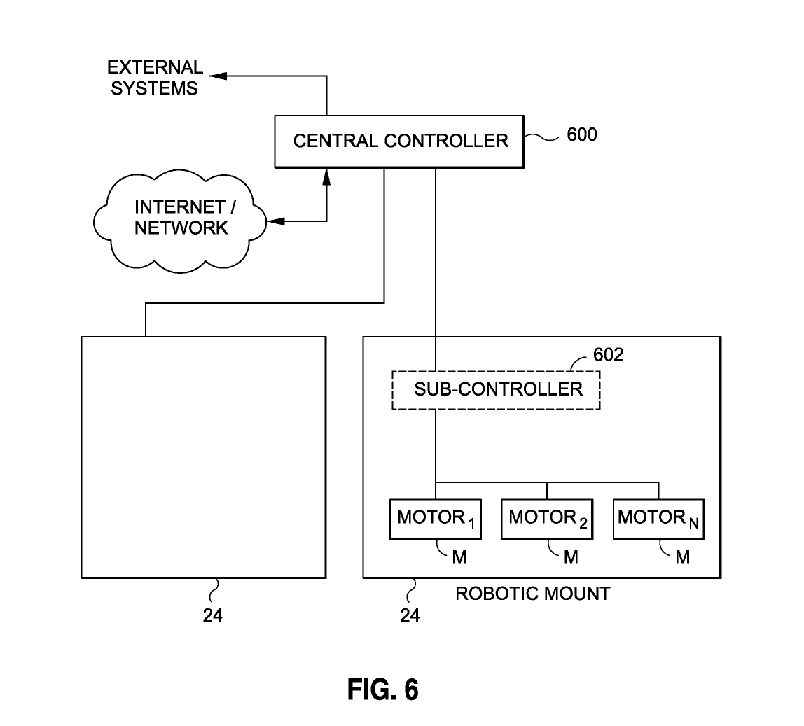

FIG. 6 illustrates on embodiment of a control system. In a preferred embodiment, the controller 600 may comprise or include a computing device. Various instructions may be provided from the controller to the one or more robots/robotic mounts 24, causing the robots/robotic mounts to move. For example, a user might provide an input to the controller 600, which input is a request to move a particular panel from a first to a second position. The controller 600 may generate one more signals or instructions which are transmitted to the required mount for causing the mount to so move the panel. The signal might comprise opening of a switch which allows electricity to flow to one or more motors M for a predetermined period time which is necessary for the motor to effect the desired movement. In another embodiment, the signal might comprise an instruction which is received by a sub-controller 602 of the mount, which sub-controller then causes the mount 24 to move as desired. The control instructions may include instructions to cause said robotic mount to drive (e.g. move from one location to another, thus changing the location of any architectural element connected thereto) and/or control instructions to change the position of the head (and thus the position or orientation of any architectural element connected thereto).

In one embodiment, the controller 600 may be configured to cause a single mount or multiple mounts to move in various patterns or other desired directions. For example, the controller 60 might be programmed to cause the panels to move in a particular pattern. Referring to FIGS. 2 and 3, for example, the controller may be configured to move the panels from the position illustrated in FIG. 2 to that illustrated in FIG. 3, or vice versa.

The controller may be custom-programmed or might be configured to execute pre-set sequences of movement. In one embodiment, the controller may include a processing unit capable of executing machine readable code or “software.” As indicated, that software may comprise a set of instructions which, when executed, cause the controller to move one or more panels in a predetermined motion or pattern, randomly or otherwise. The software might also or instead simply comprise a set of instructions which permits a user to provide manual input to cause a panel or panels to move, either in direct response thereto or to generate a “programmed” movement (which may be implemented immediately or be stored for implementation at a later time).

The controller might communicate with the robotic mount via wired or wireless communications. For example, the controller might comprise a desk-top computer running a control program. The desk-top computer might transmit signals via a RS-232 communication link including a wired pathway to the motor or controller of the robotic mount. Alternatively, the desk-top computer and mount controller might both include wireless transceivers. In this manner, the controller and robotic mount(s) may be located remotely from one another. The same computer might output images or a video feed to the one or more displays of an architectural element.

In one embodiment, video information may be transmitted to the display or displays either independently of control instructions or dependently therewith. For example, the controller may be configured to both generate display information and/or transmit display information to the displays, and control the mounts. The controller might be configured to move the mounts/displays based upon the information which is displayed by the one or more displays. In one embodiment, the one or more displays may be moved synchronously with information displayed by the displays. For example, the displays might be moved synchronously with images displayed by the displays or with music or other accompanying information.

The invention has numerous advantages. As explained above, one aspect of the invention is robotically moveable panels to reconfigure a residential, industrial, or commercial space. A further aspect of the invention is a movable display. The panels comprising or including one or more electronic video displays may preferably be moved six degrees of freedom (i.e. in and about three axes which are all perpendicular to one another). In one embodiment, the display-type panel is mounted to a mount having a support which is movable in six degrees of freedom. Preferably, means are provided for automatically or remotely moving the panel. As indicated, this may comprise changing the position of one or more portions of the robotic mount. Such display panels may be used as ceiling, wall, floor, divider or other architectural elements and at the same time be used to display images, video or the like. For example, a divider wall may be constructed from a plurality of display panels and those panels may be used to display advertising information during a convention; a floor may be constructed from one or more display panels which display directions (arrows, footprints) or other information, whereby the panels may be used to enhance a structure.

One aspect of the invention is a method of remotely or automatically changing the position of a panel. For example, a person may desire the configuration of a room to be changed at a predetermined time. As another example, the position of a panel may be changed at various times in an automatic fashion (as opposed to a “manual” manner, where the position is changed by a person physically moving the display or its associated mount). This has the advantage that the position of a panel may be moved for various purposes, such as for aesthetics, to increase or decrease the space of a room, for entertainment purposes or the like.

As one example, a convention space may have a large floor. For a first convention the floor may need to be divided up by locating structural panels in a first configuration about the convention floor. For a second convention the floor may need to be divided up by locating structural panels in a second configuration about the convention floor. In accordance with the present invention, those panels may be moved by one or more robotic mounts. For example, in one configuration, the floor layouts may be programmed into a computer which generates instructions which cause the one or more robot mounts to move the panels to positions which correspond to the floor layouts.

As another example, a large warehouse might be divided by a central divider based upon the use levels of spaces on either side of the divider. The divider might comprise a robotically controlled divider, whereby changes in position of the divider might be automated.

It in accordance with the invention, the configuration of a portion of an architectural element to be modified or changed. In other embodiments, it is possible for the entire configuration of a structure to be changed. For example, the size of a building might be increased by robotically moving floor, wall and/or ceiling/roof elements into adjoining position to an existing structure.

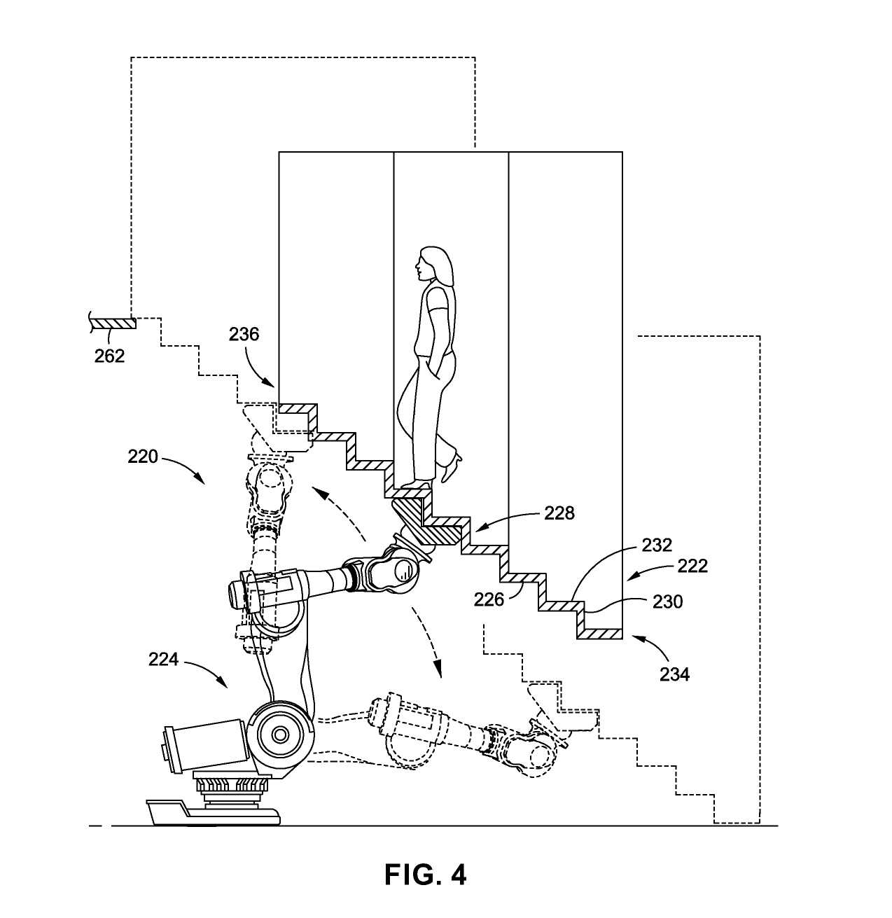

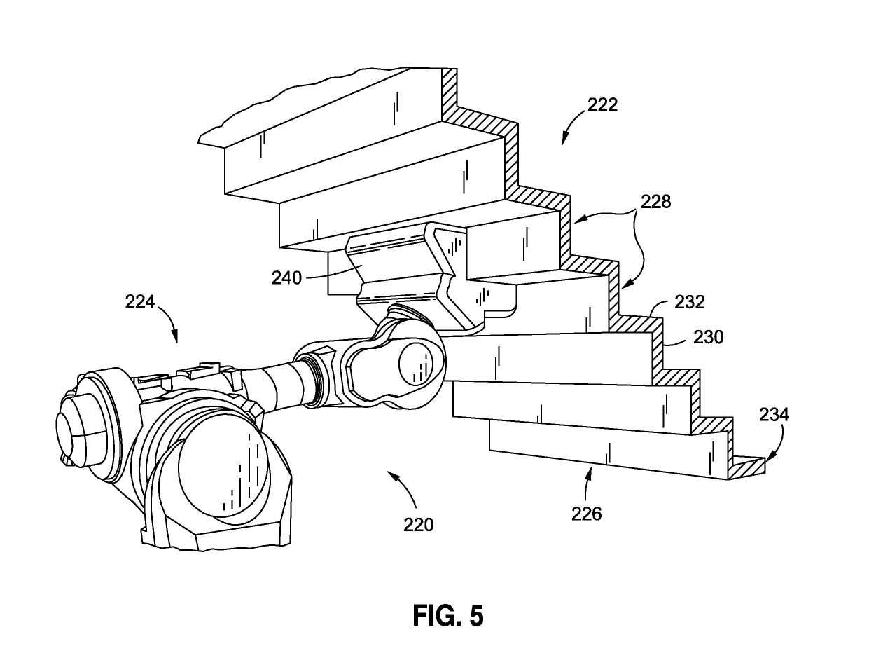

FIGS. 4 and 5 illustrate another embodiment of the invention in which the robotically controlled architectural element comprises a staircase 222. The robotically controlled staircase 220 comprises a staircase 222 and a robot or robotic mount 224 which is configured to move the staircase 222.

The staircase 222 may have various configurations. In one embodiment, the staircase 222 comprises a supporting body or structure 226. The staircase 222 preferably includes a plurality of steps 228. Each step 228 may comprise a riser 230 and a landing 232. Each riser 230 preferably extends generally vertically upward. The number of steps 228, and thus the number of risers 230, may vary. Preferably, there is at least one step 228. More preferably, however, there are a plurality of steps 228. The depth of each landing 232 and the height of each riser 230 may be configured to conform to local building or other codes.

Preferably, the staircase 222 has a first or bottom end 234 and a second or top end 236. The top end 236 is preferably higher than the bottom end 234. The total change in elevation is dependent upon the number of steps 228 and the height of the risers 230. The staircase 222 may be straight or it might be spiral, have one or more bends or the like.

In one embodiment, the staircase 222 may be configured to mate with one or more other elements or structures. For example, the staircase 222 may be configured to dock or mate to a supporting platform (not shown). To this end, the top end 236 and bottom end 234 of the staircase 222 may end or terminate in a landing 232. This allows the top and bottom ends 236,234 to rest upon a supporting surface or platform at generally the same elevation thereof. In one embodiment, the landing at the top end 236 and/or bottom end 234 of the staircase 222 may be larger than the step landings 232. For example, each of the top and bottom end landings may be sufficiently large to permit one more persons to easily stand thereon (whereas the step landings are primarily configured to permit a user to simply step thereon as they climb the staircase).

In one embodiment, the staircase 222 may include other features. For example, the staircase 222 may include one or more handrails (not shown). The staircase 222 has a width between opposing sides. This width may vary, such as being 36 or 48 inches, for example. A handrail may be located at each side of the staircase to prevent a user from falling off of the staircase and to provide support to users. Likewise, the landing 232 at the top end 236 and bottom end 234 of the staircase 222 may include an enclosure. Such an enclosure may be selectively opened and closed to permit ingress to and egress from the staircase, but prevent such during movement of the staircase. Such an enclosure might comprise a rail, a chain, or the like. For example, a swinging gate may be located at both the top and bottom ends 236,234 of the staircase 222 to control ingress to and egress from the staircase 222.

In one embodiment, the body 226 of the staircase 222 might comprise a superstructure which supports the steps 228. For example, the body 226 might comprise a metal framework. The steps 228 might be constructed from wood and be supported by that framework. In another embodiment, the body 226 might define the steps 228. For example, the staircase 222 might be constructed from metal, such as step elements which are welded to one another to form a unitary structure.

The mount 224 preferably comprises a robot or robotic mount similar to that described above and will thus not be described herein again in detail (for example, such may comprise a base and a moveable support, as detailed above). In particular, the mount 224 is configured to move the staircase 222 in at least two (2), and preferably three (3) dimensions. As also indicated above, the robotically controlled staircase 220 may also include a controller to move the staircase 222 in certain paths.

As best illustrated in FIG. 5, the staircase 222 is preferably mounted to the mount 224. As illustrated, an adaptor 240 may be used to connect the staircase 222 and the robotic mount 224. The adaptor 240 may have various configurations. FIG. 5 illustrates one configuration in which the adaptor 240 engages a bottom portion of one or more of the steps 228. However, the adaptor 240 could have other configurations, such as depending upon the configuration of the staircase 222, including the body 226 or supporting structure thereof.

As illustrated in FIG. 4, the robotic mount 224 is configured to move the staircase 222 between various positions. For example, the robotic mount 224 may move the staircase 222 into a position in which its bottom end 234 is positioned on the ground. A user may then step onto the staircase 222 from the ground, such as by stepping onto a lower landing 232 thereof.

The robotic mount 224 may then be used to move the staircase 222, and the user standing thereon, to another location. In the preferred embodiment where the robotic mount 224 can move in three dimensions, the staircase 222 may be moved to various positions in three-dimensional space which vary from an initial or starting position. FIG. 4 illustrates one simplistic embodiment where the staircase 222 is moved in two dimensions: upwardly and forwardly. In this example, the staircase 222 may be moved upwardly and forwardly, such as to dock with a raised platform 262. A user might then disembark from the staircase 222 onto the platform 262.

It will be appreciated that a user may climb up and down the steps 228 of the staircase 222 both while the staircase 222 is stationary and/or while it is moving. For example, a user might board the staircase 222 at the bottom end 234 while it is stationary. As the staircase begins to move to a destination, the user might climb the steps 228 to the top end 236 of the staircase 222 to disembark the staircase 222 at the destination.

The robotically controlled staircase 220 might be used in various manners. For example, it might be used in a theater. In such an environment a singer might be transported from stage level to a platform well above stage, or from one location to another over a barrier such as a moat. The robotically controlled staircase 220 might also be used as an amusement ride. In such an embodiment, patrons might board the staircase 220 as a ride and be transported from one location to another. In one preferred embodiment, a haunted house ride might include one or more platforms in various locations. The platforms might lead to doors or other points of entry. Patrons might board the staircase and be transported to one or more of those platforms where they disembark to travel into other portions of the haunted house. In one embodiment, the staircase might move between various locations before stopping, thus providing substantial anticipation to the riders as to their final destination. It is also possible for there to be more than one robotically controlled staircase 220. The various staircases 220 might move independently between various locations. They might also move so that they join together at certain times (forming longer staircases to connect to various locations, for example) or independently at other times). As yet another example, a first robotically controlled staircase 220 might be used to move patrons from ground level to one or more platforms at a first level (above ground) and then a second robotically controlled staircase 220 might be used to move patrons from the first level to an even higher second level (or higher).

As indicated, one or more controllers may be used to control the robotically controlled staircase 220, such as to cause it to move between various locations. The patterns of movement may change over time. For example, in a haunted house ride, the robotically controlled staircase 220 might be configured to move a first set of riders from ground level to a first platform. However, the robotically controlled staircase 220 might be configured to move a second set of riders from that same ground level to a second, different platform.

Of course, the robotically controlled staircase 220 might be configured to move between various locations other than ground level and various platforms. The robotically controlled staircase 220 may include several of the other features detailed herein. For example, the robotically controlled staircase 220 may be controlled by one or more controllers, such as to move in certain patterns or paths, including synchronously with other elements. For example, the robotically controlled staircase 220 may be moved synchronously with music which is being played or with images that are being displayed.

As indicated above, other robotically movable architectural elements are contemplated. Such elements include, for example, plumbing elements (including but not limited to valves, controllers, delivery pipes, drain pipes, sewer pipes, nozzles and other elements), HVAC elements (ducts, air movers, heating and/or cooling elements, intake and exhaust elements, grates, filters, controllers and other elements), and electrical elements (wiring, breakers, control boxes, switches, solar panels and other elements), and structural members (braces, panels, floors, doors, windows, walls, shutters, screens, covers, shelves, ceilings, trusses, supports, pillars and other elements) of a residential, industrial, or commercial space.

For example, robotic mounts may be used to modify the layout of internal and/or external plumbing of a building. The robotic mounts may robotically detach, move, and reattach a modular section of pipe using standard apparatuses installed in a building for the distribution of potable water and the removal of waterborne wastes. Such pipes may be made of, for example, steel, copper brass, plastic, or other suitable materials.

The modification of the plumbing allows, for example, the modification of a room or building's waste-disposal system by disconnecting, relocating, and reinstalling pipes between various fixture drains to the central main and terminating at the sewage system.

Various plumbing fixtures in a room or building may be equipped with quick-connect attachments for releasably attaching to the modular section of pipe or other plumbing feature. The modular section of pipe may thus be detached from one fixture, moved to a new location, and be reinstalled in another quick-connect attachment of a separate plumbing fixture.

As another example, robotic mounts may be used to modify HVAC systems, such as by disconnecting, relocating, and reinstalling pipes, ductwork or other elements, such as between air handling devices (swamp coolers, fans, air conditioners or other elements) and air outlets (vents, etc.) or other elements of ductwork or the like.

Additionally, the HVAC of a room or building may be robotically modified. For example, a central heating, ventilation, and air conditioning system provides warmth, cooling, air flow, and exhaust to a portion of or the whole interior of a building from a central location to multiple rooms. The system is facilitated by a series of ductwork. This ductwork may also be robotically modified.

Such ductwork in an HVAC system provide airflows including, for example, supply air, return air, and exhaust air. Ducts also deliver, most commonly as a part of the supply air, ventilation air. As such, air ducts are one method of ensuring acceptable indoor air quality as well as thermal comfort. Such ducts can be made out of galvanized mild steel, may be made out of a flexible material.

Central heat generation occurs in one place, such as a furnace room in a house or a mechanical room in a larger building. The resultant heat is then distributed typically by forced-air through the ductwork. The ductwork vents or flues carry the products of combustion and expel them from the building. Cooled air from a central air-conditioner generally uses the same ductwork for distribution.

In this embodiment, a robotic mount, such as the one already described, disconnects, relocates, and installs one or more duct sections or section based on saved data of duct design in the robot controllers. Similar to the plumbing example described above, the ductwork of a room or building may have a number of predetermined attachment points. The robotic mount may be configured to detach one or more duct sections from one of the attachment points, relocate the one more duct sections to a new location, and install the one or more duct sections to a separate attachment point.

Furthermore, the electrical components or systems of a room or building may be robotically modified. Typically, electrical systems in building begin at a step-down transformer provided by a utility company and located within or in close proximity to the building. The transformer reduces the potential from a standard line potential to one or more voltages for use in the building. The electricity then passes through master switches and electric meters, to circuit breaker, and is eventually separated into circuits for use in the building.

Such electrical work for these circuits is typically distributed through wall partitions, ceilings, and the like. The electrical work then runs to electrical boxes for outlets, switches, light fixtures, etc. located throughout rooms of a building.

Similar to the above described robotically controlled plumbing and HVAC, the layout of low-voltage power and wiring starting at the output of a circuit breaker and terminating at a switch, power outlet, light fixture, etc. may be robotically modified. A robotic mount disconnects, relocates, and installs a low-voltage conduit and wire section or sections based on saved data of electrical designs in the robot controller. The robotic mount may also disconnect and reconnect various services made available at the circuit breaker. The robotic mount may further disconnect and reconnect various services at wall switches, receptacle outlets, and light fixtures.

It is also possible that one or more panels 22 or staircases 222 include sections of pipe, ductwork, and/or electrical in predetermined positions. The pipe, ductwork, and/or electrical may have predetermined quick-connect attachment points on one more external surfaces of the panels 22 and staircases 222. Accordingly, when the panels 22 and staircases 222 are moved and positioned as described above, a plumbing, HVAC, and electrical system of the room or building may be simultaneously altered.

As indicated above, where the architectural elements are configured to be moved by a robotic mount, the architectural elements may be permanently affixed to the robotic mount, or are more preferably releasably connectable thereto, such as to a head or other mount of the robotic mount. This permits a single robotic mount to be connected to and thus move more than one architectural element. For example, a single robotic mount at a convention center might pick up, move and assemble a stack of multiple panels in order to form a partition.

In one embodiment, the architectural elements are modular, such as being in “cartridge” format. Preferably, the configuration of the architectural elements: (1) facilitates attachment and detachment of the architectural element to and from the robotic mount and (2) facilitates the connection of the architectural element to a structure and/or other architectural elements.

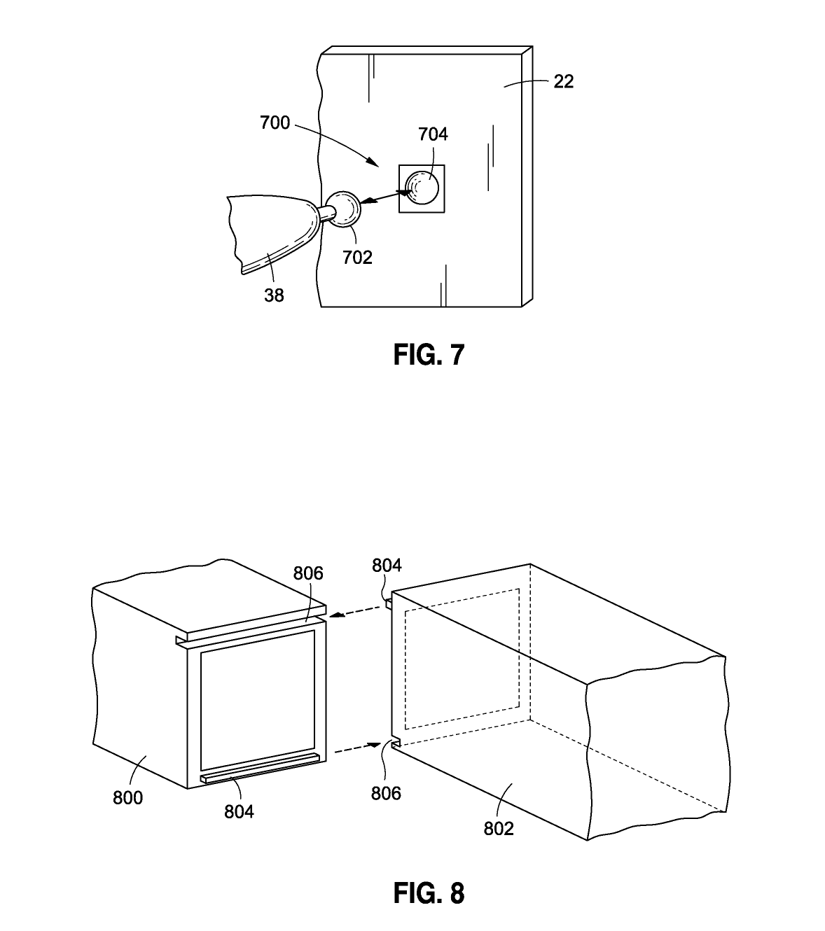

In one embodiment, such as illustrated in FIG. 7, the robotic mount and the architectural element have a releasable connector 700 which permit the robotic mount and architectural element to be selectively or releasably connected. In one embodiment, a means for connecting may permit connection and disconnection without user intervention. For example, the head 38 of the robotic mount might comprise a ball 702 which can be engaged with or disengaged from a corresponding socket 704 on the architectural element 22. As another example, the head of the robotic mount might comprise a threaded stud which can be threaded into a corresponding passage of the architectural element. The head might also comprise a gripper (such as an openable/closeable claw) or other element which can grasp a portion of the architectural element (such as a flange or gripping area thereof). In general, the means for releasably or selectively connecting a robotic mount to and disconnecting a robotic mount from, an architectural element, may comprise various connectors, couplers or other members or elements now known or later developed.

An architectural element might include one robotic mount connector, such as in a particular location to cause the robotic mount to connect and support the architectural element in a particular position. In other embodiments, the architectural element might have more than one robotic mount connector, such as to permit a robotic mount to connect to it in various positions, etc.

Likewise, in one embodiment, as indicated above, the architectural element may include one or more mounts or connectors which facilitate its connection or mounting to other members, whether they be a portion of a structure or another architectural element. For example, cartridge-type duct sections might include mating pins and slots which allow the members to be guided together and securely connected under the control/movement of one or more robotic mounts, thus reducing or even eliminating the need for manual effort in connecting the members. For example, as illustrated in FIG. 8, a duct sections 800,802 may include mating pins 804 and slots 806 at the ends thereof. When aligned, the pins 804 and slots 806 allow the duct sections 800,802 to be moved laterally into engagement/alignment (so that air flow passages there through are aligned and the sections 800,802 are connected) or out of engagement with one another.

While each of the above embodiments have been described separately to facilitate understanding, it should be understood that such elements may be configured together. For example, a fully modifiable residential, industrial, or commercial space may be created with the above described features. For example, each of the walls, floors, ceilings, stairs, plumbing, HVAC, and electrical may be robotically constructed and modified as explained above. With these combined elements an entire space of building may be robotically modified for aesthetics, to create multi-use spaces according to various configurations, and/or to increase or decrease the size of the space.

Aspects of the invention may be utilized for various purposes. As indicated herein, aspects of the invention comprise methods and systems for modifying the configuration of a structure (walls, ceiling, floors, interior space layout, etc.) or a system thereof (HVAC, electrical, plumbing, etc.). The methods and systems of the invention may be utilized for various purposes, including but not limited to: artistic purposes (such as to change the aesthetic design of a structure or change the shadows coming off of the structure); seasons (such as changing the configuration of a structure based upon the position of the sun in the sky associated with seasons, such as to orient the structure or features thereof towards the sun in winter and away from the sun in summer); weather (such as to storm-proof a structure before an upcoming storm or for a particular season); holidays; special events; security; “away” times such as when a business in a structure is closed for business during a certain time of day or certain time period; time of day and for various other reasons/purposes.

As indicated herein, various controls or controllers may be utilized to facilitate aspects of the invention. Such controllers may be used to program and thus automate operation of the robotic mounts and accomplish the methods herein. In some embodiments, the robotic mounts or the associated controllers may be linked to or communicate with various systems, such as external systems. As one example, as illustrated in FIG. 6, a central control system may be configured to control one or more robotic mounts. The central control system might communicate with the Internet or other systems to obtain and exchange information. For example, a central control system may obtain weather forecast information which indicates an imminent storm. The central control system may utilize this information to transmit control instructions to one or more robotic mounts to effectuate a “storm proofing” of a structure, such as by mounting or closing shutters over doors and windows, angling louvers, deploying patio covers or the like.

In one embodiment of the invention, control instructions for causing one or more robotic mounts to change the location and/or position of one or more architectural elements may thus be generated based upon a weather forecast or current weather conditions, astronomical data (including but not limited to a season of the year, equinox, the position of one or more stars or planets, tide, position or phase of the moon, position of the earth, time of day and time of year), desired shadow generation, events and various other criteria as described herein.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of changing the configuration of a structure comprising the steps of:
connecting a robotic mount to a first architectural element, said robotic mount comprising a base which is movably mounted and a head which is movably mounted relative to said base in at least three degrees of freedom via at least one motor, said head connected to said first architectural element;
transmitting first control instructions from a controller to said robotic mount to cause a location of said robotic mount to change from a first location to a second location, thereby moving said first architectural element from said first location to said second location;
transmitting second control instructions from said controller to said robotic mount to cause said robotic mount to move said head to position said first architectural element in a desired position; and
disconnecting said robotic mount from said first architectural element.

2. The method in accordance with claim 1 wherein said first architectural element comprises a wall panel, a ceiling panel, a floor panel, a shutter, an HVAC component, an electrical system component or a plumbing component.

3. The method in accordance with claim 1 wherein base is movably mounted by at least one drive member driven by at least one drive motor and said first control instructions comprise motor instructions to operate said at least one drive motor.

4. The method in accordance with claim 1 wherein said head is mounted to said base by two or more arms which permits said head to be moved in said at least three degrees of freedom.

5. The method in accordance with claim 1 wherein said head comprises a first connector for selective engagement with a mating second connector on said first architectural element.

6. The method in accordance with claim 1 wherein said controller comprises at least one computing device having at least one processor configured to generate said first and second control instructions.

7. The method in accordance with claim 1 wherein said first architectural element comprises a modular panel, HVAC, electrical, plumbing or structural component having at least one first mount for connection to said head of said robotic mount and configured to matingly connect to another architectural element.

8. The method in accordance with claim 1 further comprising the step of connecting said head of said robotic mount to a second architectural element and utilizing said robotic mount to connect said second architectural element to said first architectural element.

9. The method in accordance with claim 1 wherein said first and/or second control instructions are based upon forecast weather data.

10. The method in accordance with claim 1 wherein said first and/or second control instructions are based astronomical data selected from the group consisting of: a season of the year, equinox, the position of one or more stars or planets, tide, position or phase of the moon, position of the earth, time of day and time of year.

11. The method in accordance with claim 1 wherein said first and/or second control instructions are based upon shadow generation of said first architectural element.

12. A method of changing the configuration of an interior space of a structure comprising the steps of:
transmitting first control instructions to a first robotic mount to cause said first robotic mount to move a first architectural panel from a first location to a second location; and
transmitting second control instructions to said first robotic mount or a second robotic mount to move a second architectural panel from third location into engagement with said first architectural panel, thereby forming a partition in said interior space, said partition comprising at least said first and second architectural panels.

13. The method in accordance with claim 12 wherein said robotic mounts comprise a base, at least one drive for changing a location of said base and a head movably connected to said base in at least three degrees of freedom.

14. The method in accordance with claim 13 wherein said at least one drive includes at least one drive motor and including at least one motor configured to change a position of said head relative to said base.

15. The method in accordance with claim 12 further comprising the steps of generating said first control instructions via at least one controller and generating said second control instructions via said at least one controller.

16. The method in accordance with claim 12 wherein said first and second control instructions comprise motor drive instructions.

17. The method in accordance with claim 12 wherein said steps of transmitting comprise wirelessly transmitting.

18. The method in accordance with claim 12 wherein said first and/or second control instructions are based upon forecast weather data.

19. The method in accordance with claim 12 wherein said first and/or second control instructions are based astronomical data selected from the group consisting of: a season of the year, equinox, the position of one or more stars or planets, tide, position or phase of the moon, position of the earth, time of day and time of year.

20. The method in accordance with claim 12 wherein said first and/or second control instructions are based upon shadow generation of said first and/or architectural element.
